(19) United States
(12) Patent Application Publication
(10) Pub. No.: US 2010/0255874 A1
(43) Pub. Date: Oct. 7, 2010

(54) DUAL MODE COMMUNICATION DEVICE AND METHOD FOR CARRYING OUT A LOUD-SPEAKING GROUP MEETING

(75) Inventor: Xiao-Bin WANG, Xi'an (CN)

Correspondence Address: Muncy, Geissler, Olds & Lowe, PLLC, 4000 Legato Road, Suite 310, FAIRFAX, VA, 22033, US

(73) Assignee: INVENTEC APPLIANCES CORP., Taipei (TW)

(21) Appl. No.: 12/755,863

(22) Filed: Apr. 7, 2010

(30) Foreign Application Priority Data
Apr. 7, 2009 (TW) 098111462

(51) Int. Cl. H04M 1/00

(52) U.S. Cl. 455/552.1

(57) ABSTRACT

A dual mode communication device includes primary and secondary communication modules for transmitting first and second communication signals, a simulated switch, a microphone and a speaker. When the primary and secondary communication modules transmit one of the first and second communication signals, the simulated switch receives a switch control signal, thereby allowing the microphone to transmit an initiating signal. When the speaker receives a respective one of the primary and secondary switch control signals, the speaker outputs the respective one of the first and second communication signals with signal strength greater than the preset signal strength of the respective one of the first and second communication signals.

This application claims the benefit of the Taiwan Patent Application Serial No. 098111462, filed on Apr. 7, 2009, the subject matter of which is incorporated herein by reference.

### BACKGROUND OF THE INVENTION

1. Field of the Invention

The present invention relates to a technology for carrying out loud-speaking group meeting, more particularly to a dual mode communication device and method for carrying out loud-speaking group meeting. Description of the

2. Prior Art

Due to rapid development in the information technology, use of communication devices is increasing day by day. In Taiwan, nearly every body possesses a mobile phone so that he can contact with other people or exchange information regardless of his whereabouts.

The communication devices available in the market includes communication modules operated under different systems, such as GSM (Global System for Mobile), CDMA (Code Division Multiple Access), 3G (3^{rd}. Generation) and PHS (Personal Handy-phone System).

A so-called dual mode communication device generally includes two communication modules different from each other. The reason for setting two different communication modules is to overcome the area limitation or switch to another system compatible with one communication module in case the communication device one working on is facing poor communication presently. The user can optionally switch to a selected communication module if he finds the operating system controlling the selected communicated module offers cheaper charges. Therefore, dual mode communication device plays a major role in the mobile communication market.

The sale of dual mode communication device has been for a considerable time and the device permits the user to switch between two communication modules, but there exist some drawbacks. The main drawback of the prior art dual mode communication device resides in that when one communication module is in use, the user cannot hear or receive the signal coming in over the other communication module. As a result, there may be missed calls for the user of the dual mode communication device.

Later, a ROC patent publication No. 20080308 reveals “dual mode portable end and method for executing multiple networks calling” to propose improvement, where the user can receive another incoming call from the remaining communication module even if he is already using a communication module. Under this condition, he can immediately switch to the other communication module in order to receive the incoming call or the incoming call is reserved for future use.

However, in the event two simultaneously incoming calls contain important messages and required immediate attention or discussions, the user is put in a dilemma. In case, the user conducts a group teleconferencing using one of the communication modules in the device, he can do so with a limited persons. The allowed persons to participate in group teleconferencing in each communication system differ from one another. It is learned that six is the maximum so that if the participants exceed six, no group teleconferencing can be carried out. As a result, a special channel is requested, only then the group teleconferencing with more than six participants can be carried out.

When a company or business establishment intends to hold a meeting, an assembly room is required to allow the staff members arrive thereat at preset time. Alternately, one can use a video phone at one end and a meeting hall at the other end, where people can watch and listen. It requires cable connection for carrying out video conferencing, thereby restricting the space. In addition, since the video phone has a profile similar to a domestic phone having a loudspeaker so that in case of using the video phone for teleconferencing due to presence of other staff nearby, the video phone must be switched to loudspeaker mode in order the attendants hear the discussion.

Therefore, the inventor feels it is indispensable to invent a dual mode communication device, in which two communication modules can be simultaneously used to conduct multiple discussions, thereby allowing more number of participants. The dual mode communication device can be used for teleconferencing wherever it can receive or transmit the signal, carrying out of teleconferencing is limited by the assembly or conference hall, thereby economizing the time and expense for gathering the participants into a preset site.

### SUMMARY OF THE INVENTION

The object of the present invention is to provide a dual mode communication device, where the primary and secondary communication modules can be simultaneously applied. In the prior art dual mode communication device, if one communication module is in use and in case of another interrupting incoming call, the user can either switch his device to receive the incoming call or reserve the incoming call for latter application, but can not receive two calls simultaneously.

The other object of the present invention is to provide a method for carrying out group meeting, where the dual mode communication device is applied for simultaneously using the primary and secondary communication modules such that upon receipt of first and second communication signals, the speaker of the communication device automatically amplifies the first and second communication signals to an loud-speaking signal strength greater than preset signal strength of the first and second communication signals.

The dual mode communication device and method for carrying out loud-speaking group meeting according to the present invention includes a primary communication module, a secondary communication module, a simulated switch, a microphone and a speaker.

In the method for carrying out loud-speaking group meeting according to the present invention, when the primary and secondary communication modules respectively transmit first and second communication signals, the simulated switch will receive a switch control signal in response to one of the first and second communication signals, thereby transmitting a initiating signal to the microphone. Moreover, in receipt of a primary and secondary switch control signal, the speaker automatically amplifies one of the first and second communication signals to a signal strength greater than preset signal strength of the first and second communication signals.

In compare to the prior art dual mode communication device, two communication modules in the present dual mode communication device can be simultaneously applied for communication. The simulated switch is coupled selectively and electrically to the primary and secondary communication modules for adjusting the communication modules such that the present communication device has dual mode communication ability.

Note that the speaker of the dual mode communication device is capable of amplifying one of the first and second communication signals to a signal strength greater than preset signal strength of the first and second communication signals. By utilizing the primary and secondary communication modules simultaneously, routine or non-routine group teleconferencing can be carried out regardless of whereabouts of the participants. Thus, assembly hall and assembling time for the participants to gather at preset site can be economized or avoided when using the dual mode communication device of the present invention.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 illustrates a diagram representing one embodiment of a dual mode communication device of the present invention;

FIG. 2 illustrates a communication log shown in a display window of a display unit employed in the dual mode of the communication device of the present invention;

FIG. 3 shows the communication information of a primary communication module employed in the dual mode of the communication device of the present invention;

FIGS. 4A and 4B respectively show a diagram representing a method for carrying out a group teleconferencing, illustrating a signal flow process within the dual mode communication device of the present invention;

FIG. 5 illustrates a teleconferencing being carried out among three participants using the dual mode communication device of the present invention;

FIG. 6 illustrates a teleconferencing being carried out among three participants, into which a fourth participant joins in using the dual mode communication device of the present invention; and

FIG. 7 illustrates a teleconferencing being carried out among four participants using the dual mode communication device of the present invention.

### DETAILED DESCRIPTION OF THE PREFERRED EMBODIMENTS

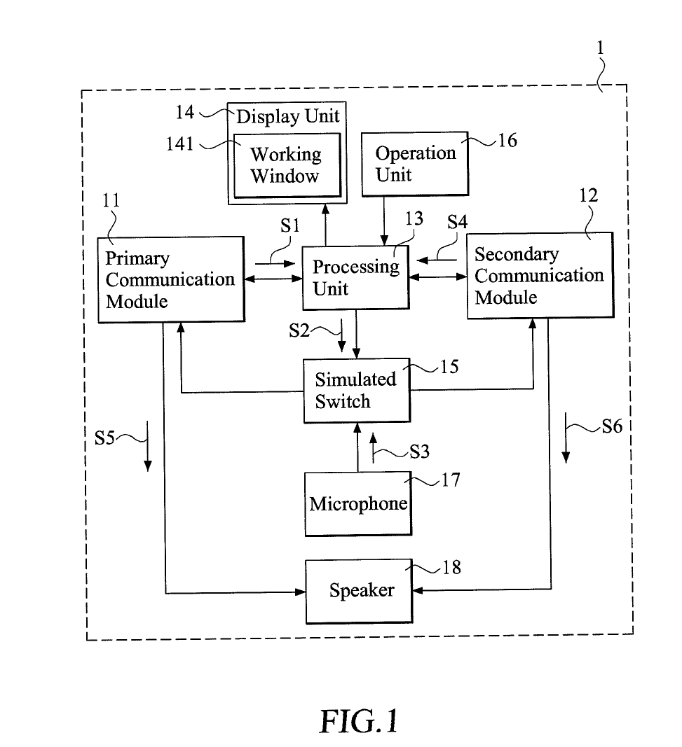

FIG. 1 illustrates a diagram representing one embodiment of a dual mode communication device of the present invention. The dual mode communication device 1 of the present invention accordingly includes a primary communication module 11, a secondary communication module 12, a processing unit 13, a display unit 14, a simulated switch 15, an operation unit 16, a microphone 17 and a speaker 18.

The primary and secondary communication modules 11, 12 are coupled electrically to the processing unit 13. The display unit 14 is coupled electrically to the processing unit 13 and is capable of displaying a working window 141.

The simulated switch 15 is coupled respectively and electrically to the primary and secondary communication modules 11, 12 and further to the processing unit 13. The operation unit 16 is coupled electrically to the processing unit 13 while the microphone 17 is coupled electrically to the simulated switch 15. The speaker 18 is coupled electrically to the primary and secondary communication modules 11, 12.

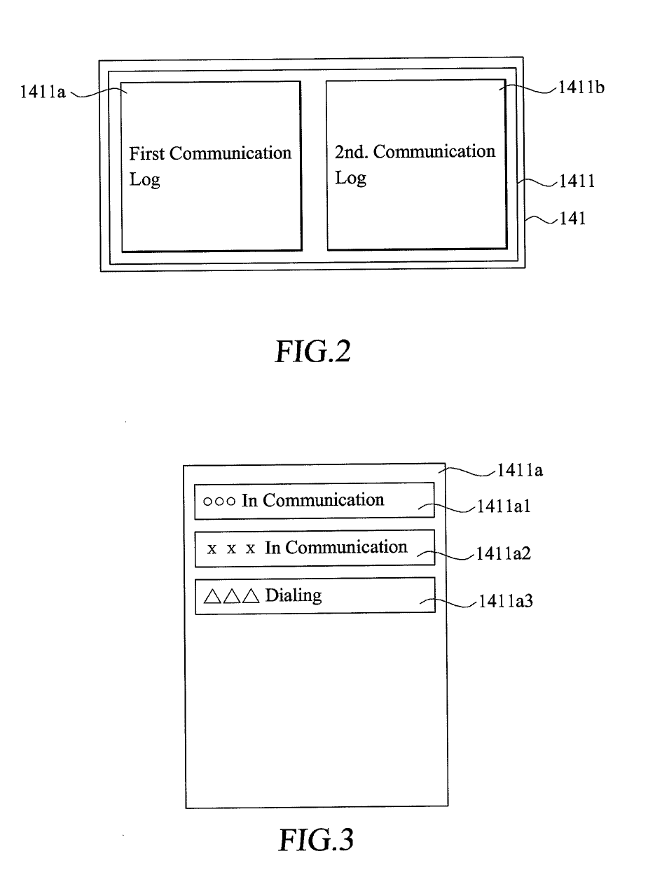

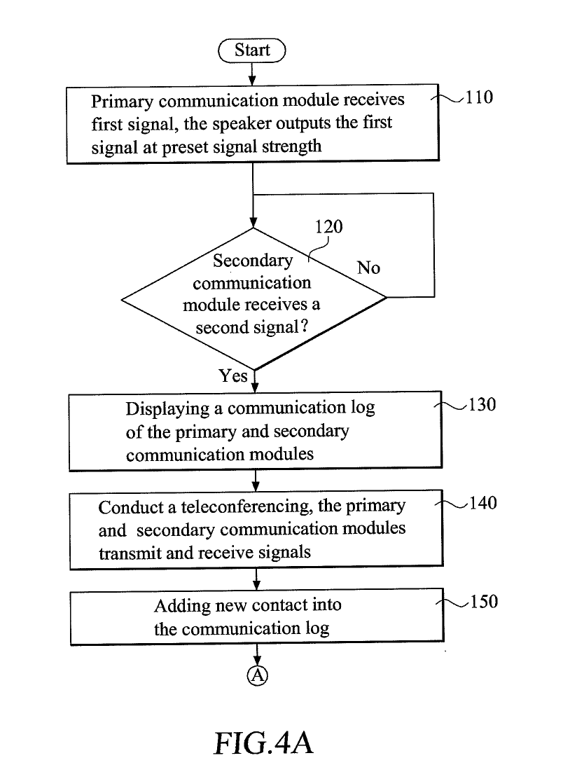

Referring to FIGS. 1, 2 and 3, wherein FIG. 2 illustrates a communication log shown in a display window of a display unit employed in the dual mode of the communication device of the present invention and FIG. 3 shows the communication information of a primary communication module employed in the dual mode of the communication device of the present invention. Upon receipt of a first communication signal S1, the primary communication module 11 transmits the signal S1 to the processing unit 13 for undergoing an execution, after which, the processing unit 13 generates and transmits a switch control signal S2 to the simulated switch 15 such that the simulated switch 15 is in electrical communication with the primary communication module 11 and the microphone 17. At this time, the display unit 14 displays a working window 141 including a first communication log 1411a of the first communication signal S1. When the user dials a number into the microphone 17, the microphone 17 transmits an initiating signal S3 (such as a dialing signal) via the simulated switch 15 and the primary communication module 11.

In the same manner, upon receipt of the second communication signal S4, the secondary communication module 12 transmits the signal S4 to the processing unit 13 for undergoing an execution, after which, the processing unit 13 generates and transmits the switch control signal S2 to the simulated switch 15 such that the simulated switch 15 is in electrical communication with the secondary communication module 12 and the microphone 17. At this time, the display unit 14 displays a working window 141 including a second communication log 1411b of the second communication signal S4. When the user dials a number into the microphone 17, the microphone 17 transmits the initiating signal S3 via the simulated switch 15 and the secondary communication module 12.

Upon receipt of the first and second communication signals S1 and S4, the primary and secondary communication modules 11, 12 of a receiving mobile phone respectively transmit the signals S1, S4 to the processing unit 13 for undergoing an execution, where, the processing unit 13 generates and transmits the switch control signal S2 to the simulated switch 15 such that the simulated switch 15 is in electrical communication with the primary and secondary communication modules 11, 12 and the microphone 17. At this time, the display unit 14 displays the working window 141 including the communication log 1411 of the first and second communication signals S1, S4.

The communication log 1411 generally includes at least one of the aforesaid first and second communication logs 1411a, 1411b of the first and second communication signals S1, S4. As illustrated, the first communication log 1411a of the first communication signal S1 consists of three pieces of contact information 1411a1, 1411a2 and 1411a3.

In other words, when the dual mode communication device 1 of the present invention transmits one of the first and second communication signals S1, S4 [i.e. (i) the first communication signals S1, (ii) the second communication signals S4, (iii) the first and second communication signals S1, S4], the simulated switch 15 will receive the switch control signal S2, thereby establishing communication between the microphone 17 and a respective one of the primary and secondary communication modules 11, 12 and sending out the initiating signal S3 via the respective one of the primary and secondary communication modules 11, 12.

When the primary communication module 11 transmits the first communication signal S1 in response to the switch control signal S2, the processing unit 13 will transmit a primary switch control signal S5 to the speaker 18 via the primary communication module 11 and the simulated switch 15. Under this condition, the speaker 18 will amplify the first communication signal S1 to a signal strength greater than preset signal strength of the first communication signal S1. In the same manner, when the secondary communication module transmits the second communication signal S4, the processing unit 13 will transmit a secondary switch control signal S6 to the speaker 18 via the second communication module 12 and the simulated switch 15. Under this condition, the speaker 18 will amplify the second communication signal S4 to a signal strength greater than preset signal strength of the second communication signal S4.

When the primary and secondary communication modules 11, 12 respectively transmit the first and second communication signals S1, S4, the processing unit 13 will transmits the primary switch control signal S5 to the speaker 18 via the primary communication modules 11 and the simulated switch 15 and the secondary switch control signal S6 to the speaker 18 via the secondary communication module 12 and the simulated switch 15. Under this condition, the speaker 18 will amplify one of the first and second communication signals S1, S4 to a signal strength greater than preset signal strength of the respective one of the first communication signals S1, S4. Thus, the dual mode communication device 1 of the present invention possesses amplifying ability.

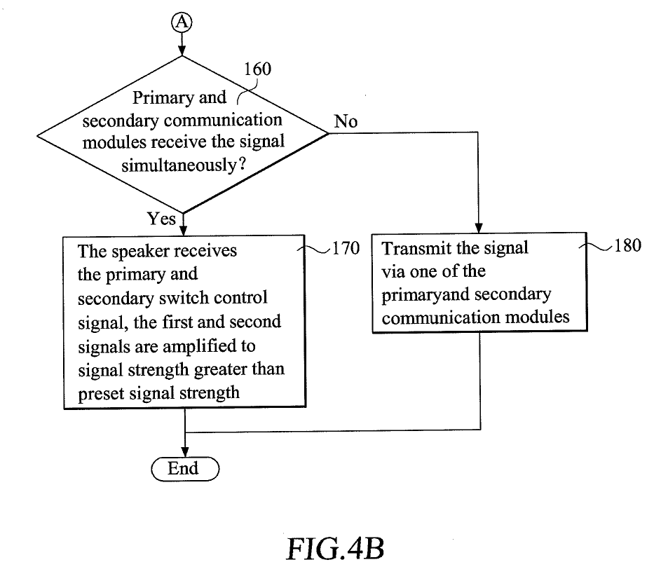

FIGS. 4A and 4B respectively show a diagram representing a method for carrying out a group teleconferencing, illustrating a signal flow process within the dual mode communication device of the present invention.

When carrying out the group teleconferencing (loud-speacking group meeting), the primary and secondary communication modules 11, 12 are utilized in such a manner to transmit the first and second communication signals S1 and S4 respectively. First of all, upon receipt of the first communication signal S1 from the primary communication module 11, the processing unit 13 transmits the aforesaid switch control signal S2 to the simulated switch 15, which establishes electrical communication between the primary communication module 11 and the microphone 17 such that the speaker 18 outputs the first communication signal S1 with the preset signal strength (step 110).

In the event, the processing unit 13 detects and finds out whether the secondary communication module 12 is in receipt of a second communication signal S4 during the conversation (step 120). If the secondary communication module 12 is in receipt of the second communication signal S4, the display unit 14 will display the communication log 1411 including several pieces of contact information 1411a1˜1411a3, meanwhile the first and second communication logs 1411a, 1411b representing the first and second communication modules are shown in the display unit 14 (step 130). If the secondary communication module 12 is not in receipt of the second communication signal S4, the process returns to the step 110, where the primary communication module 11 is applied for carrying out the conversation.

In case of preparing a group teleconferencing (loud-speaking meeting) and in order to inform the participants, the operation unit 16 is manipulated, thereby urging the primary or secondary communication modules 11, 12 to receive or transmit the communication signal (step 140). At the same time, the signals (new contact information) transmitted from or received by the primary and secondary communication modules 11, 12 are added into the communication log 1411 (step 150).

At this time, in case the primary and secondary communication modules 11, 12 respectively transmit the first and second communication signals S1, S4 and in case the user decides whether to transmit the first and second communication signals with a signal strength greater than the preset signal strength, he can switch on the speaker thereby changing into the teleconferencing mode (160). The loud-speaking signal strength of the respective signal is generally equivalent to the user's tone in the communication device so that the communicators within the same communication modules may hear relative voices or from the communicators within the other communication modules. Under this condition, all the communicators may feel that they are confined within an assembly hall for group meeting.

During the step 160, in case the speaker 18 is in receipt of the primary and secondary switch control signals S5, S6, the speaker 18 will automatically amplify the first and second communication signals S1, S4 to the signal strength greater than the preset signal strength of the first and second communication signals S1, S4. At this time, the microphone 17 transmits the initiating signal S3 to the primary and secondary communication modules 11, 12 via the simulated switch 15 for carrying out the teleconferencing (170). During the step 160, in case the speaker 18 is not in receipt of the primary and secondary switch control signals S5, S6, the operation unit 16 can be manipulated so as to transmit the switch control signal S2 to the simulated switch 15 via the processing unit 13 so as to select a respective one of the primary and secondary communication modules 11, 12. In addition, the microphone 17 is capable of transmitting the initiating signal S3 to the selected communication module (step 180).

Preferably, the primary and secondary communication modules 11, 12 are to work respectively under any two different standards selected from the group consisting of GSM (Global System for Mobile) standard, CDMA (Code Division Multiple Access) based standards, other 3G (3^{rd} Generation) standards and PHS (Personal Handy-phone System) standard.

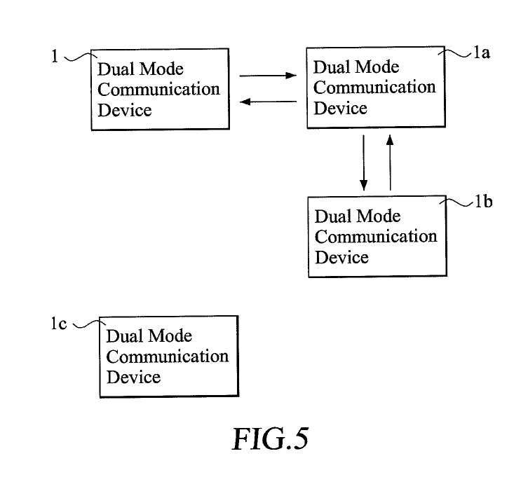

FIG. 5 illustrates a teleconferencing (loud-speaking group meeting) being carried out among three participants using the dual mode communication devices of the present invention. As illustrated, when the dual mode communication device 1a receives calls transmitted by the dual mode communication device 1 and the dual mode communication device 1b, the user can switch on the speaker in order to carry out a teleconferencing among the three participants.

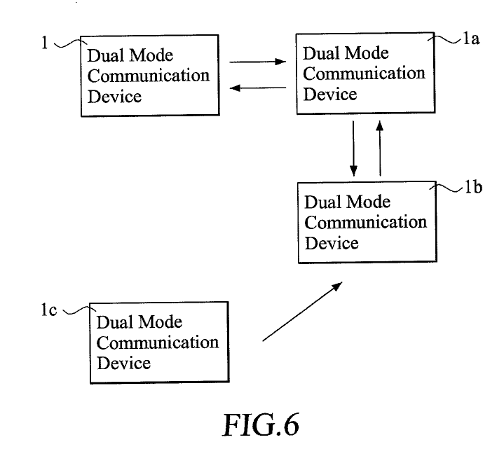

FIG. 6 illustrates a teleconferencing (loud-speaking group meeting) being carried out among three participants, into which a fourth participant joins in using the dual mode communication devices of the present invention. As illustrated, three persons are carrying out a loud-speaking group meeting using the dual mode communication devices 1, 1a, 1b respectively. During the conversation, the user of the dual mode communication device 1b receives a call transmitted from the dual mode communication device 1c so that the new corner is invited into the group meeting.

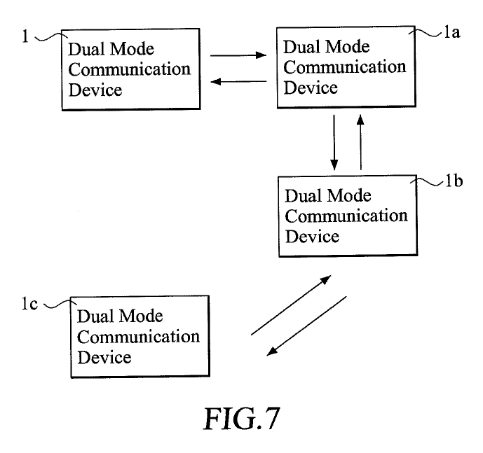

FIG. 7 illustrates a teleconferencing (loud-speaking group meeting) being carried out among four participants using the dual mode communication devices of the present invention. As illustrated, two persons are carrying out a loud-speaking group meeting respectively using the dual mode communication devices 1b, 1c. In case, another dual mode communication device 1c is used to dial to the dual mode communication device 1b, which is on line with the communication devices (1,1a), the communication device 1c is also linked to the dual mode communication devices (1,1a), thereby allowing the four participants to carry out a group meeting.

Unlike to the prior art communication device, the primary and secondary communication modules 11, 12 in the dual mode communication device 1 of the present invention can be simultaneously manipulated for transmission and reception of signals. Moreover, since the simulated switch 15 is coupled to the primary and secondary communication modules 11,12 respectively, the processing unit 13 can transmit the switch control signal S2 to the simulated switch 15 in order to permit simultaneous manipulation of the primary and secondary communication modules 11, 12.

As described above, the primary and secondary communication modules 11, 12 in the dual mode communication device 1 of the present invention can be simultaneously manipulated for transmission and reception of signals. In addition, if circumstances required, the speaker in the dual mode communication device 1 of the present invention can be switched to amplify the first and second signals S1, S4 to a signal strength greater than the preset signal strength. The problems of assembly time and assembling space can be avoided when using the dual mode communication device of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A dual mode communication device comprising:
a primary communication module for transmitting a first communication signal;
a secondary communication module for transmitting a second communication signal;
a simulated switch coupled respectively and electrically to said primary and secondary communication modules and having a function of receiving a switch control signal when the dual mode communication device transmits at least one of said first communication signal or said second communication signal;
a microphone coupled electrically to said simulated switch, and having a function of coupling electrically to at least one of said primary communication module or said secondary communication module according to said switch control signal to allow transmission of an initiating signal through at least one of said primary communication module or said secondary communication module;
a processing unit coupled electrically to said primary and secondary communication modules and said simulated switch for transmitting said switch control signal to said simulated switch when said processing unit receives at least one of said first communication signal or said second communication signal; and
a speaker coupled electrically to said primary and secondary communication modules for amplifying at least one of said first communication signal or said second communication signal.

2. The dual mode communication device according to claim 1, further comprising an operation unit coupled electrically to said processing unit for transmitting an operation signal to cause said processing unit to transmit said switch control signal.

3. The dual mode communication device according to claim 1, further comprising a display unit coupled electrically to said processing unit and for displaying a communication log containing communication information transmitted by at least one of said first communication signal or said second communication signal.

4. The dual mode communication device according to claim 1, wherein said primary and secondary communication modules are to work respectively under any two different standards selected from the group consisting of a GSM (Global System for Mobile communications) standard, CDMA (Code Division Multiple Access) based standards, other 3G (3^{rd} Generation) standards and a PHS (Personal Handy-phone System) standard.

5. A method for carrying out a loud-speaking group meeting by a dual mode communication device comprising a primary communication module, a secondary communication module and a speaker, wherein the speaker has a function of changing at least one of a first communication signal transmitted by said primary communication module or a second communication signal transmitted by said secondary communication module into at least a signal of a preset signal strength, and the method comprises:
(a) utilizing the primary and secondary communication modules to transmit at least one the first or second communication signals;
(b) upon receipt of a respective one of the first and second communication signals, the primary and secondary communication modules of a receiving mobile phone transmitting a primary switch control signal and a secondary switch control signal to the speaker; and
(c) upon receipt of said primary and secondary switch control signals, the speaker automatically amplifying the respective one of the first communication signal or the second communication signal into a loud-speaking signal strength greater than the preset signal strength.

6. The method according to claim 5, wherein the step (a) further includes a substep (a0): displaying a communication log containing communication information transmitted by at least one of said first communication signal or said second communication signal within a working window of a display unit.

7. The method according to claim 5, wherein the step (a) further includes a substep (a1): utilizing an operation unit to transmit an initiating signal through at least one of said primary communication module or said secondary communication module in order to carry out the loud-speaking group meeting.

8. The method according to claim 7, wherein the step (b) further includes a substep (b0): upon receipt of the respective one of said first and second communication signals, the primary and secondary communication modules of said receiving mobile phone transmitting the primary and secondary switch signals via a simulated switch.

9. The method according to claim 7. wherein the step (c) further includes a substep of (c0); utilizing an operation unit to terminate transmission of the respective one of said first and second communication signals.
